(19) United States
(12) Patent Application Publication
(10) Pub. No.: US 2018/0312946 A1
(43) Pub. Date: Nov. 1, 2018

(54) METAL ALLOY FOR ADDITIVE MANUFACTURING OF MACHINE COMPONENTS

(71) Applicant: Nuovo Pignone Srl, Florence (IT)

(72) Inventors: Michael Francis Xavier GIGLIOTTI, Jr., Niskayuna, NY (US); John Broddus DEATON, Jr., Niskayuna, NY (US); Massimo GIANNOZZI, Florence (IT); Iacopo GIOVANNETTI, Florence (IT); Pierluigi TOZZI, Florence (IT)

(21) Appl. No.: 15/524,076

(22) PCT Filed: Oct. 28, 2015
(86) PCT No.: PCT/EP2015/074992

§ 371 Date: May 3, 2017

(30) Foreign Application Priority Data
Nov. 3, 2014 (IT) FI2014A000245

(51) Int. Cl. C22C 38/30; B22F 5/00; B22F 1/00; B22F 5/04; C22C 19/07; C22C 38/22; C22C 38/26; C22C 38/04; C22C 38/02; C22C 38/00; B33Y 70/00

(52) U.S. Cl. CPC C22C 38/30; B22F 5/009; B22F 1/0011; B22F 5/04; C22C 19/07; C22C 38/22; B22F 3/1055; C22C 38/04; C22C 38/02; C22C 38/002; C22C 38/001; B33Y 70/00; C22C 38/26

(57) ABSTRACT

Metal alloys are disclosed, comprising at least cobalt, nickel, iron and carbon, wherein: the content of cobalt is at least about 20% by weight; the content of iron and cobalt in combination is comprised between about 40% and about 70% by weight; the content of nickel is comprised between about 5% and about 25% by weight; and the content of carbon is more than 0% but less than about 0.05% by weight.

### BACKGROUND

The present disclosure relates to the manufacturing of machine components, in particular machine components which are subject to high temperature operating conditions, such as components of internal combustion engines and turbomachines, e.g. but not limited to stationary (statoric) components of gas turbines. More specifically, exemplary embodiments of the subject matter disclosed herein relate to alloys intended for the manufacture of turbomachine components, such as statoric parts of gas turbines.

Internal combustion engine components, such as gas turbine components, must be manufactured with metal alloys which are capable of withstanding high-temperature operating conditions. This is particularly true for components which are located near the combustors of the gas turbine, i.e. the turbine nozzles and turbine blades of the high pressure power turbine stages. The combustion gas temperature in the first stage nozzles can be 1100° C. or higher, while in the most downstream turbine stages the temperature drops to around 650-700° C.

Special high-temperature, nickel-based alloys are used for manufacturing rotary components, such as the blades of the first turbine stages. These alloys are expensive but are required in view of need to withstand the combined effect of high temperature and high dynamic stresses generated in the rotary part of the turbomachine.

Stationary components, such as nozzles, stationary buckets or other statoric parts of gas turbines are often manufactured using less expensive Co-based alloys, such as FSX414. These materials have relatively high carbon content, in the range of 0.2-0.3% by weight and are commonly used in casting processes. Carbon tends to precipitate in the form of carbides, which provide high mechanical strength.

Stationary turbomachine components have often a complex shape. Manufacturing thereof would take advantage of modern additive manufacturing techniques, such as DMLM (Direct Metal Laser Melting) technology. Additive manufacturing allows complex mechanical components to be manufactured starting from a file containing data on the shape of the final article of manufacture to be produced, which data are directly used to control an energy source, such as a laser source or an electron beam.

Commonly used additive manufacturing alloys, such as CoCrMo alloys, however, have been proved unsatisfactory for manufacturing of turbomachine components which are operating under high-temperature conditions. This is particularly due to the formation of a brittle phase above 900° C. operating temperature.

On the other hand, FSX414 alloys are unsuitable for additive manufacturing processes, as they give rise to cracks during fast cooling of the sequentially melted layers of powder material.

### SUMMARY OF THE INVENTION

There is thus a need for a metal alloy which is economically affordable and technically suitable for additive manufacturing of high-temperature turbomachine components.

An exemplary embodiment comprises metal alloy for manufacturing of gas turbine components by means of an additive manufacturing process, comprising: at least cobalt, nickel, iron and carbon, wherein the content of cobalt is at least about 20% by weight the content of iron and cobalt in combination is comprised between about 40% and about 70% by weight the content of nickel is comprised between about 5% and about 25% by weight and the content of carbon is more than 0% but less than about 0.05% by weight.

A method for manufacturing a gas turbine component, the method comprising: providing a metal powder made of a metal alloy comprising at least cobalt, nickel, iron and carbon, wherein: the content of cobalt is at least 20% by weight; the content of iron and cobalt in combination is comprised between 40% and 70% by weight; the content of nickel is comprised between 5% and 25% by weight; and the content of carbon is more than 0% but less than 0.05% by weight; forming said component by an additive manufacturing process using said metal powder.

### DETAILED DESCRIPTION

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

According to one aspect, novel Co-based or Fe-based metal alloys are proposed, which overcome or alleviate one or more of the disadvantages of known metal alloys and which are particularly suitable for additive manufacturing of high-temperature machine components, in particular statoric components of gas turbines.

According to some embodiments, a metal alloy for manufacturing of gas turbine components by means of an additive manufacturing process is provided. The alloy comprises: at least about 20% by weight of cobalt, a total content of iron and cobalt comprised between about 40% and about 70% by weight a content of nickel comprised between about 5% and about 25% by weight, and more than 0% but less than about 0.05% by weight of carbon.

The alloy can be in powder form. In some embodiments the powder alloy can have an average grain size between about 10 and about 60 micrometers.

The presence of carbon in the alloy improves the mechanical resistance of the machine components made of the alloy described herein, due to the precipitation of carbides in the molten metal. By reducing the amount of carbon under 0.05% by weight, it has been surprisingly noted that formation of cracks during cooling of the melted powder layers is prevented or substantially reduced, making the use of the alloy suitable also for additive manufacturing.

According to some embodiments, the alloy can further include tungsten (W) in an amount ranging between about 5% and about 10% by weight, and in an example between about 2% and about 8% by weight and even more in an example between about 2.5% and about 7% by weight.

In some embodiments, the alloy contains not less than 10% by weight of nickel and in an embodiment between about 10% and about 20% by weight of nickel.

According to some embodiments, the alloy contains from about 20% to about 30% by weight of chromium.

Suitable alloy composition ranges are summarized in the following Tables 1 and 2. Compositions are expressed as percentage by weight (% wt):

TABLE 1
(cobalt based)

| Ni | Co | Cr | W | Fe | C | Mo + Si + B + N + Mn + Nb |
|---|---|---|---|---|---|---|
| 10-20 | Bal. | 20-30 | 2-8 | 1-20 | <0.01 | <6.5 |

TABLE 2
(iron based)

| Ni | Co | Cr | W | Fe | C | Mo + Si + B + N + Mn + Nb |
|---|---|---|---|---|---|---|
| 10-20 | 20-25 | 20-30 | 2-8 | Bal. | <0.01 | <6.5 |

The following Table 3 contains four exemplary compositions of alloys according to the present disclosure. All values are expressed in % wt (percentage by weight):

TABLE 3

| Ni | Co | Cr | Mo | W | Nb | Fe | C | Si | B | N | Mn |
|---|---|---|---|---|---|---|---|---|---|---|---|
| 10 | Bal. | 29 | — | 7 | — | 1 | <0.05 | — | 0.01 | — | — |
| 10 | Bal. | 29 | — | 7 | — | — | <0.05 | — | 0.01 | — | — |
| 20 | 21 | 21 | 3 | 2.5 | 1 | Bal | <0.05 | 0.75 | | 0.15 | 1.5 |
| 20 | Bal. | 21 | 3 | 2.5 | 1 | 20 | <0.05 | 0.75 | | 0.15 | 1.5 |

The amount of iron vs. cobalt can be higher or lower depending upon the performances required. Higher iron content reduces the cost of the alloy and results in lower performance at higher temperatures. Higher iron contents are therefore in an embodiment used for machine components where less stringent temperature-resistance requirements must be met.

According to a further aspect, the present disclosure relates to a method for manufacturing a gas turbine component, and more specifically a statoric gas turbine component. In some embodiments, the gas turbine component is a stationary gas turbine nozzle, blade or bucket. According to embodiments of the subject matter disclosed herein, the method comprises the following steps: providing a metal powder made of a metal alloy comprising at least cobalt, nickel, iron and carbon, wherein: the content of cobalt is at least about 20% by weight; the content of iron and cobalt in combination is comprised between about 40% and about 70% by weight; the content of nickel is comprised between about 5% and about 25% by weight; and the content of carbon is more than 0% but less than about 0.05% by weight; forming said component by an additive manufacturing process using said metal powder.

As known to those skilled in the art, the additive manufacturing process comprises the following steps: depositing a first layer of powder material onto a target surface; irradiating and at least partly melting a first portion of a first layer of powder material with a high-energy source and solidifying the first portion of powder material; said first portion corresponding to a first cross-sectional region of said component; depositing a second layer of powder material onto the first layer; irradiating and at least partly melting a second portion of the second layer of powder material with the high-energy source and solidifying the second portion of powder material, said second portion corresponding to a second cross-sectional region of said component, the first portion and the second portion being joined to one another; depositing successive layers of powder material onto the previous layers and irradiating and at least partly melting a portion of each successive layer to produce said component, each layer portion corresponding to a cross-sectional region of said component.

Several high-energy sources can be used as additive manufacturing sources of energy. Depending upon the source of high-energy used, the additive manufacturing process can be selected from the group consisting of: electron beam melting (EBM), selective laser melting (SLM), selective laser sintering (SLS), laser metal forming (LMF), direct metal laser sintering (DMLS), direct metal laser melting (DMLM).

It is to be understood that even though numerous characteristics and advantages of various embodiments have been set forth in the foregoing description, together with details of the structure and functions of various embodiments, this disclosure is illustrative only, and changes may be made in detail, especially in matters of structure and arrangement of parts within the principles of the embodiments to the full extent indicated by the broad general meaning of the terms in which the appended claims are expressed. It will be appreciated by those skilled in the art that the teachings disclosed herein can be applied to other systems without departing from the scope and spirit of the application.

What is claimed is:

1. A metal alloy for manufacturing of gas turbine components by means of an additive manufacturing process, the metal alloy comprising:
at least cobalt, nickel, iron and carbon, wherein:
the content of cobalt is at least about 20% by weight
the content of iron and cobalt in combination is comprised between about 40% and about 70% by weight
the content of nickel is comprised between about 5% and about 25% by weight
and the content of carbon is more than 0% but less than about 0.05% by weight.

2. The metal alloy according to claim 1, wherein the metal alloy is in powder form.

3. The metal alloy according to claim 2, wherein the powder has an average grain size between about 10 and about 60 micrometers.

4. A method for manufacturing a gas turbine component, the method comprising:
providing a metal powder made of a metal alloy comprising at least cobalt, nickel, iron and carbon, wherein: the content of cobalt is at least about 20% by weight; the content of iron and cobalt in combination is comprised between about 40% and about 70% by weight; the content of nickel is comprised between about 5% and about 25% by weight; and the content of carbon is more than 0% but less than about 0.05% by weight;
forming said component by an additive manufacturing process using said metal powder.

5. The method of claim 4, wherein said additive manufacturing process is selected from the group consisting of: electron beam melting, selective laser melting, selective laser sintering, laser metal forming, direct metal laser sintering, direct metal laser melting.

6. The method of claim 4, wherein the gas turbine component is a statoric gas turbine component.
